(19) United States
(12) Patent Application Publication
(10) Pub. No.: US 2007/0171265 A1
(43) Pub. Date: Jul. 26, 2007

(54) Ink supply apparatus of inkjet printing system

(75) Inventors: Young-ki Hong, Anyang-si (KR); Tae-gyun Kim, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/518,929

(22) Filed: Sep. 12, 2006

(30) Foreign Application Priority Data
Jan. 26, 2006 (KR) 2006-8246

(51) Int. Cl. B41J 2/175

(52) U.S. Cl. 347/85

(57) ABSTRACT

An ink supply apparatus of an inkjet printing system includes an ink tank including a pressure port and an ink supply opening connected to a print head, a flexible ink package connected to the ink supply opening to accommodate ink, and a pressure supply device to supply a purging pressure to the ink package by supplying a pressure fluid to the ink tank.

### CROSS-REFERENCE TO RELATED APPLICATIONS

This application claims priority under 35 U.S.C. §119(a) from Korean Patent Application No. 10-2006-0008246, filed on Jan. 26, 2006, in the Korean Intellectual Property Office, the disclosure of which is incorporated herein in its entirety by reference.

### BACKGROUND OF THE INVENTION

1. Field of the Invention

The present general inventive concept relates to an ink supply apparatus of an inkjet printing system, and more particularly, to an ink supply apparatus of an inkjet printing system to purge gas bubbles from a print head.

2. Description of the Related Art

In general, an inkjet print head is a device for printing a color image on a surface of a print target, such as paper or fabric, by ejecting minute droplets of ink onto desired locations on the print target.

Inkjet print heads are manufactured as a form of a chip using various methods, including semiconductor fabrication processes, and packaged and mounted in printing devices. An inkjet printing system includes a frame on which a print head is mounted and an ink supply apparatus for supplying ink to the print head.

During a print job, a consistent ink supply from an ink tank to a print head is ensured by a head difference between the ink tank and the print head and a negative pressure generated by ejecting the ink. The ink may also be forcibly supplied from the ink tank to the print head using a pumping device.

Purging removes air from an ink flow channel in a print head and an ink supply path from an ink tank to the print head. Purging can be performed by supplying ink contained in the ink tank to the print head using a tubing pump. The tubing pump is a type of positive displacement pump, and thus, a fixed quantity of ink can be supplied, but pressure control is not easy. Thus, problems such as an internal cracking of the print head due to excessive pressure may occur. Another conventional method to remove air is to apply air pressure to the ink tank. However, in this case, the ink may be degenerated by direct contact with air. If the degenerated ink is supplied to the print head, an ejection performance of the print head may be affected. In addition, since the ink is in continuous contact with air, air may be absorbed into the ink and generate gas bubbles in the print head.

### SUMMARY OF THE INVENTION

The present general inventive concept provides an ink supply apparatus of an inkjet printing system to prevent a degeneration of ink and an air inflow into the ink during filling and purging processes.

The present general inventive concept also provides an ink supply apparatus of an inkjet printing system to maintain a fixed ink pressure during filling and purging processes.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink supply apparatus of an inkjet printing system to supply ink to a print head, the ink supply apparatus including an ink tank comprising a pressure port and an ink supply opening connected to the print head, a flexible ink package connected to the ink supply opening to accommodate the ink, and a pressure supply device to supply a purging pressure to the ink package by supplying a pressure fluid to the ink tank.

The ink supply apparatus may further include a pressure regulator located between the pressure supply device and the pressure port to control the pressure of the pressure fluid to have a constant level.

The pressure fluid may include air.

The ink supply apparatus may further include a 3-way valve mounted between the pressure regulator and the pressure port to selectively supply the purging pressure or atmospheric pressure to the ink package.

The ink tank may further include a through hole through which air passes, and the ink supply apparatus may further include a first valve mounted between the pressure regulator and the pressure port and a second valve in the through hole to selectively supply the purging pressure or atmospheric pressure to the ink package.

The ink package may include at least one of a flexible air impermeable film, a flexible air impermeable film coated with a metallic thin film, a flexible material having an air impermeable film, and a flexible material coated with a metallic thin film.

The foregoing and/or other aspects and utilities of the present general inventive concept may also be achieved by providing an ink supply apparatus of an inkjet printing system including an inkjet print head, the ink supply apparatus including an ink tank comprising a flexible ink package to contain ink, a pressure supply device to supply a constant purging pressure to the flexible ink package to discharge air from the inkjet print head, and a valve to supply a constant atmospheric pressure to the ink tank to provide the ink from the flexible ink package to the inkjet print head.

The supplied constant purging pressure may be a purging fluid supplied to the ink tank. The ink supply apparatus may further include a pressure regulating device to maintain the purging pressure at a constant predetermined pressure. The pressure regulating device may maintain the purging pressure at about 0.05 Mpa. The pressure regulating device may be disposed between the pressure supply device and the ink tank. The valve may include a single valve to control the supply of the purging fluid and the supply of the atmospheric pressure to the ink tank. The ink supply apparatus may further include a second valve to control the supply of the purging fluid to the ink tank. The ink supply apparatus may further include a tube to connect the flexible ink package to the inkjet print head. The flexible ink package may be air impermeable. The flexible ink package may include at least one of nylon, a fluoropolymer, polyethylene, and polypropylene.

The foregoing and/or other aspects and utilities of the present general inventive concept may also be achieved by providing a method to supply ink from an ink supply apparatus to an inkjet print head, the method including supplying a purging fluid to an ink tank of the ink supply apparatus to apply a constant purging pressure to a flexible ink package disposed in the ink tank to discharge air from the inkjet print head, and supplying a constant atmospheric pressure to the ink tank using a valve of the ink tank to provide the ink from the flexible ink package to the inkjet print head.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating an inkjet printing system using an ink supply apparatus, according to an embodiment of the present general inventive concept;

FIG. 2 is a perspective view illustrating an inkjet head of the inkjet printing system illustrated in FIG. 1, according to an embodiment of the present general inventive concept;

FIGS. 3A and 3B are views illustrating a configuration of the ink supply apparatus illustrated in FIG. 1, according to an embodiment of the present general inventive concept; and

FIG. 4 is a view illustrating the configuration of the ink supply apparatus illustrated in FIG. 1, according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

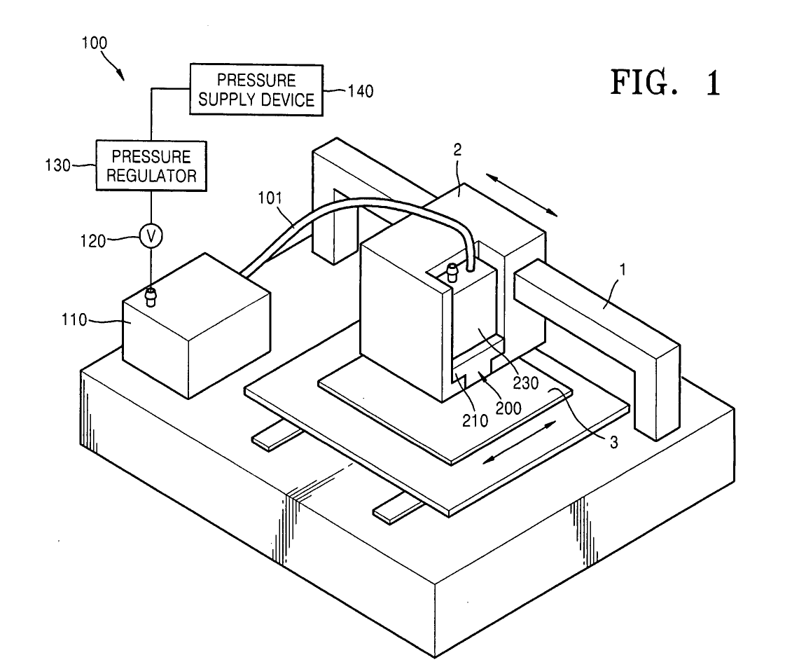

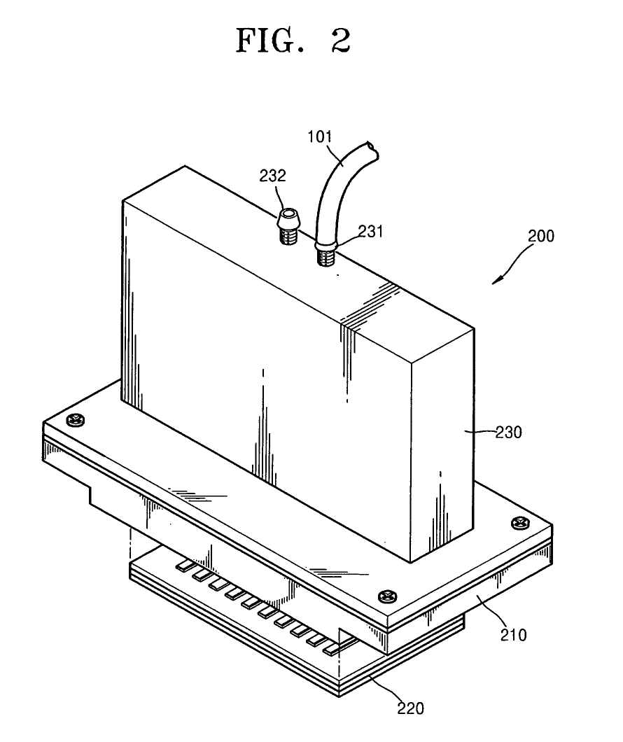

FIG. 1 is a perspective view illustrating an inkjet printing system using an ink supply apparatus 100, according to an embodiment of the present general inventive concept. FIG. 2 is a perspective view illustrating an inkjet head 200 of the inkjet printing system illustrated in FIG. 1, according to an embodiment of the present general inventive concept.

Referring to FIGS. 1 and 2, a print head 220 is manufactured as a form of a chip using various methods, including semiconductor fabrication processes, and is mounted on a frame 210. The print head 220 may also include an ink channel (not illustrated), a plurality of nozzles (not illustrated), and an ejector (not illustrated). The ink channel may include a manifold (not illustrated), a plurality of restrictors (not illustrated), and a plurality of pressure chambers (not illustrated). The plurality of nozzles may be respectively connected to the plurality of pressure chambers. Inkjet print heads can be largely divided into two types according to their ink ejection method: a heat driving type inkjet print head and a piezoelectric type inkjet print head. The heat driving type inkjet print head generates gas bubbles in ink using a heat source as an ejector, and ejects the ink using an expansive force of the gas bubbles. On the other hand, the piezoelectric type inkjet print head uses a piezoelectric body as an ejector and ejects the ink using pressure applied to the ink due to variation of the piezoelectric body. The structure of the print head 220 is well known to those of ordinary skill in the art, and thus a more detailed description is omitted.

An ink reservoir 230 is assembled with the frame 210 and connected to the print head 220. The ink reservoir 230 can include a pre-heater (not illustrated) to heat ink to maintain a viscosity suitable to print a desired image, and a negative pressure generator (not illustrated) to generate a negative pressure in the ink channel so that ink does not leak through the nozzles while printing is not being performed.

The inkjet head 200 including the frame 210, the print head 220, and the ink reservoir 230 is installed in a carriage 2. The carriage 2 is moveable along a guide member 1 by a driving device (not illustrated). A print target 3 can be fed in a direction perpendicular to a movement direction of the carriage 2.

An inkjet printing system and an inkjet head according to embodiments of the present general inventive concept are not limited to the structures illustrated in FIGS. 1 and 2.

Before a print job is performed, the print head 220 must be filled with ink. In addition, gas bubbles (for example, air bubbles) should be removed from the ink channel in the print head 220 and from the ink supply path between an ink tank 110 and the print head 220. In particular, if no printing has been performed for a period of time, if a print job is performed for a first time, or if the ink tank 110 has been replaced, a filling operation to fill the print head 220 with ink and a purging operation to discharge air from the print head 220 should be performed. In addition, air mixed in through nozzles of the print head 220 during a print job, air absorbed in ink, and other gaseous components grow to gas bubbles under various conditions, such as a temperature increase. The gas bubbles in the print head 220 decrease an ejection performance of the print head 220. In addition, a volume of the gas bubbles increases when the temperature increases, thereby causing ink to leak through the nozzles by breaking a pressure balance in the print head 220. In this case, the purging operation to discharge air from the print head 220 should be performed. Since the filling and purging operations can be performed simultaneously in practice, the filling and purging operations will be collectively described as a purging operation without discriminating between the filling and purging operations. In addition, a pressure used in the purging operation is referred to as a purging pressure.

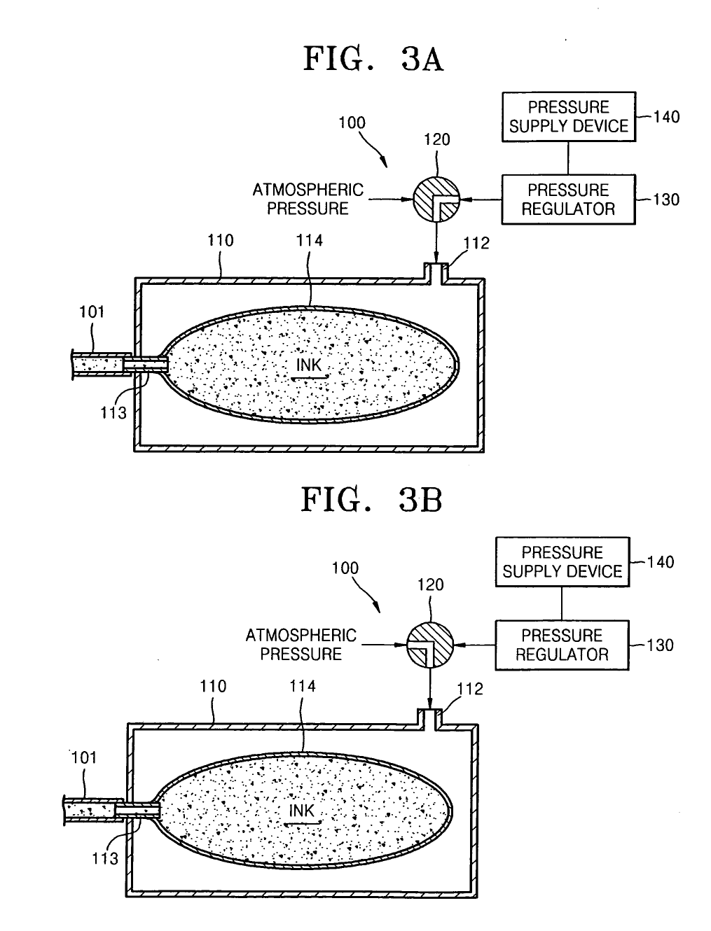

FIGS. 3A and 3B are views illustrating a configuration of the ink supply apparatus 100 illustrated in FIG. 1, according to an embodiment of the present general inventive concept. Referring to FIGS. 3A and 3B, the ink tank 110 includes a pressure port 112 and an ink supply opening 113. A flexible ink package 114 is installed inside the ink tank 110. The ink package 114 is connected to the ink supply opening 113. The ink supply opening 113 is connected to one end of a tube 101 connected to the ink reservoir 230. The other end of the tube 101 is connected to an ink entry 231 of the ink reservoir 230. Ink supplied from the ink tank 110 is supplied to the print head 220 via the ink reservoir 230.

A pressure supply device 140 supplies a pressure fluid into the ink tank 110 via the pressure port 112. By doing supplying the pressure fluid, a purging pressure is applied to the ink package 114. The pressure fluid is not specific, and may be, for example, air. The pressure supply device 140 can be one of various types of compressors commercially available. When the ink supply apparatus 100 according to the present embodiment is applied to an industrial inkjet printing system, the pressure supply device 140 can be an air pressure line from an industrial compressed air supply facility.

The ink package 114 forms a boundary between the ink accommodated inside of the ink package 114 and air inside the ink tank 110 (i.e., outside of the ink package 114). When a pressure difference exists between the inside and the outside of the ink package 114, air may be absorbed into the ink package 114 due to gas diffusion. Thus, the ink package 114 may be made of a flexible, non air-permeable material, such as a high molecule substance (e.g. Nylon, Teflon (fluoropolymer), Polyethylene (PE), or Polypropylene (PP)). In addition, the ink package 114 can be made of a material obtained by coating a thin metal film (e.g., aluminum) on the flexible film described above. In addition, the ink package 114 can be made of a flexible material having a non-air-permeable film made of the same substance as the flexible film.

If the purging pressure is excessive, the ink channel in the print head 220 can be damaged. Thus, the purging pressure must be controlled to a suitable level. Accordingly, the ink supply apparatus 100 also includes a pressure regulator 130 to supply a pressure fluid at a constant pressure to the ink tank 110 while a purging operation is performed. The pressure regulator 130 outputs the pressure fluid supplied by the pressure supply device 140 at a predetermined pressure, and is commercially available with various specifications according to an output pressure range, a type of fluid, etc. Thus, a suitable product for the pressure regulator 130 can be selected considering the structure of the ink supply apparatus 100 and the purging pressure range. The purging pressure may be, for example, 0.05 MPa (gauge pressure). In this case, suitable examples of the pressure regulator 130 include, but are not limited to, IR2000-02-X63 (manufactured by SMC corporation) and Type 100 Part No. 100-AA (manufactured by ControlAir Inc.). Since the structure and operational principles of the pressure regulator 130 are well known to those of ordinary skill in the art, a detailed description of the structure of the pressure regulator 130 is omitted.

A valve 120 may be used to selectively supply atmospheric pressure or the purging pressure to the ink package 114. The valve 120 is located between the pressure port 112 and the pressure regulator 130. The valve 120 may be, for example, a 3-way valve that can be switched to a first state to supply atmospheric pressure to the ink package 114, a second state to supply the purging pressure to the ink package 114, and a third state (i.e., an off state) to supply neither of the atmospheric pressure or the purging pressure to the ink package 113.

When a print job is performed, the valve 120 is switched to the first state as illustrated in FIG. 3B, thereby applying atmospheric pressure to the ink package 114 via the pressure port 112. Then, ink is continuously supplied from the ink package 114 to the print head 220 due to a difference between atmospheric pressure and a negative pressure generated by the print head 220 to eject the ink.

When no print job has been performed for a period of time, when a print job is performed for the first time, when the ink tank 110 (or the ink package 114) has been replaced, or when an ink ejection performance is degraded due to bubbles, the purging operation is performed. In this case, the valve 120 is switched to the second state as illustrated in FIG. 3A. Air is provided by the pressure supply device 140 at a predetermined purging pressure by passing through the pressure regulator 130. The air flows into the ink tank 110 via the pressure port 112 to apply the purging pressure to the ink package 114. Then, the ink in the ink package 114 is supplied to the ink reservoir 230 via the tube 101 by the purging pressure. After filling the ink reservoir 230, the ink fills the ink channel in the print head 220.

When a print job is performed for the first time, the tube 101 and the ink reservoir 230 are filled with air instead of ink. In addition, when the ink tank 110 (or the ink package 114) is replaced, large amounts of air can enter the tube 101. To discharge the air to outside of the ink reservoir 230, the ink reservoir 230 can also include an air discharge opening 232. If the ink flows into the tube 101 and the ink reservoir 230 due to the purging pressure, the air is discharged to the outside of the ink reservoir 230 through the air discharge opening 232. Air in the print head 220 is discharged to outside of the print head 220 through the nozzles.

When no print job has been performed for a period of time, or when an ink ejection performance is degraded due to bubbles, not much air is present in the tube 101 and the ink reservoir 230, but enough bubbles to affect the ink ejection performance exists in the print head 220. These bubbles are discharged to the outside through the nozzles by the purging pressure.

As described above, in the ink supply apparatus 100 according to the present embodiment, the ink is not in direct contact with a pressure fluid (such as air) during the purging operation or the print operation. Thus, degeneration of the ink due to contact with air can be prevented. Also, foreign substances (such as dust) can be prevented from clogging the ink channel in the print head 220. In addition, bubbles in the print head 220 are prevented by avoiding air or other gaseous components from being absorbed into the ink. Moreover, by manufacturing the ink package 114 using a non air-permeable material, an inflow of gas into the ink by gas diffusion can be prevented. Furthermore, by maintaining a constant purging pressure using the pressure regulator 130, damage to the print head 220 due to an excessive purging pressure can be prevented.

By selectively applying the purging pressure or atmospheric pressure to the ink package 114, switching between a purging operation to an ink supply job to print can be performed using a very simple structure. Since the ink is supplied from the ink package 114 to the print head 220 by atmospheric pressure during printing, an additional ink pump to supply the ink to the print head 220 is unnecessary.

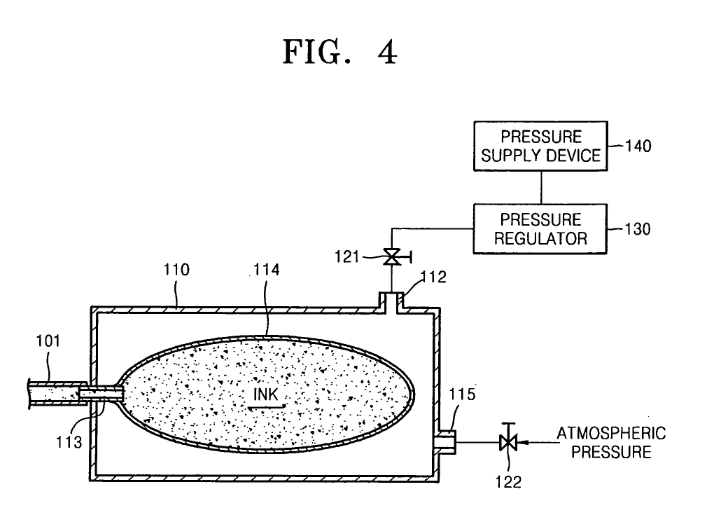

According to another embodiment of the present general inventive concept, an ink tank 110 can include a pressure port 112 and a through hole 115 through which air passes to switch between the purging operation and the ink supply operation, as illustrated in FIG. 4. A first valve 121 to control a pressure fluid is located between a pressure regulator 130 and the pressure port 112. A second valve 122 to admit atmospheric pressure is located in the through hole 115. When a print operation is performed, the pressure fluid is blocked by closing the first valve 121, and atmospheric pressure is applied to an ink package 114 by opening the second valve 122. When a purging operation is performed, the purging pressure is applied to the ink package 114 by opening the first valve 121 and closing the second valve 122.

As described above, according to the present general inventive concept, since ink is not in contact with a pressure fluid to provide a purging pressure during a purging operation, a degeneration of ink, an inflow of gas into the ink, and an inflow of foreign substances into the ink can be prevented.

In addition, by maintaining the purging pressure at a constant level, damage to the print head due to excessive purging pressure can be prevented.

In addition, an ink supply system having a very simple structure can be implemented by selectively applying the purging pressure or an atmospheric pressure to an ink package.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink supply apparatus of an inkjet printing system to supply ink to a print head, the ink supply apparatus comprising:
an ink tank comprising a pressure port and an ink supply opening connected to the print head;
a flexible ink package connected to the ink supply opening to accommodate the ink; and
a pressure supply device to supply a purging pressure to the ink package by supplying a pressure fluid to the ink tank.

2. The ink supply apparatus of claim 1, further comprising:
a pressure regulator located between the pressure supply device and the pressure port to control the pressure fluid to have a constant pressure.

3. The ink supply apparatus of claim 2, wherein the pressure fluid comprises air.

4. The ink supply apparatus of claim 3, further comprising:
a 3-way valve mounted between the pressure regulator and the pressure port to selectively supply the purging pressure or atmospheric pressure to the ink package.

5. The ink supply apparatus of claim 3, wherein:
the ink tank further comprises a through hole through which air passes; and
the ink supply apparatus further comprises a first valve mounted between the pressure regulator and the pressure port and a second valve in the through hole to selectively supply the purging pressure or atmospheric pressure to the ink package.

6. The ink supply apparatus of claim 3, wherein the ink package comprises:
at least one of a flexible air impermeable film, a flexible air impermeable film coated with a metallic thin film, a flexible material having an air impermeable film, and a flexible material coated with a metallic thin film.

7. An ink supply apparatus of an inkjet printing system including an inkjet print head, the ink supply apparatus comprising:
an ink tank comprising a flexible ink package to contain ink;
a pressure supply device to supply a constant purging pressure to the flexible ink package to discharge air from the inkjet print head; and
a valve to supply a constant atmospheric pressure to the ink tank to provide the ink from the flexible ink package to the inkjet print head.

8. The ink supply apparatus of claim 7, wherein the supplied constant purging pressure is a purging fluid supplied to the ink tank.

9. The ink supply apparatus of claim 7, further comprising:
a pressure regulating device to maintain the purging pressure at a constant predetermined pressure.

10. The ink supply apparatus of claim 9, wherein the pressure regulating device maintains the purging pressure at about 0.05 Mpa.

11. The ink supply apparatus of claim 9, wherein the pressure regulating device is disposed between the pressure supply device and the ink tank.

12. The ink supply apparatus of claim 7, wherein the valve comprises:
a single valve to control the supply of the purging fluid and the supply of the atmospheric pressure to the ink tank.

13. The ink supply apparatus of claim 7, further comprising:
a second valve to control the supply of the purging fluid to the ink tank.

14. The ink supply apparatus of claim 7, further comprising:
a tube to connect the flexible ink package to the inkjet print head.

15. The ink supply apparatus of claim 7, wherein the flexible ink package is air impermeable.

16. The ink supply apparatus of claim 15, wherein the flexible ink package comprises at least one member selected from the group consisting of nylon, a fluoropolymer, polyethylene, and polypropylene.

17. A method to supply ink from an ink supply apparatus to an inkjet print head, the method comprising:
supplying a purging fluid to an ink tank of the ink supply apparatus to apply a constant purging pressure to a flexible ink package disposed in the ink tank to discharge air from the inkjet print head; and
supplying a constant atmospheric pressure to the ink tank using a valve of the ink tank to provide the ink from the flexible ink package to the inkjet print head.
